(19) United States
(12) Patent Application Publication
(10) Pub. No.: US 2026/0099077 A1
(43) Pub. Date: Apr. 9, 2026

(54) OPTICAL MODULATOR, LIGHT SOURCE MODULE, OPTICAL ENGINE, AND XR GLASSES

(71) Applicant: TDK CORPORATION, Tokyo (JP)

(72) Inventors: Hiroki HARA, Tokyo (JP); Yasuhiro TAKAGI, Tokyo (JP)

(73) Assignee: TDK CORPORATION, Tokyo (JP)

(21) Appl. No.: 19/345,786

(22) Filed: Sep. 30, 2025

(30) Foreign Application Priority Data
Oct. 8, 2024 (JP) 2024-176250

(51) Int. Cl. G02F 1/21; G02B 27/01; G02F 1/225

(52) U.S. Cl. CPC G02F 1/212; G02B 27/0172; G02F 1/2255; G02B 2027/0178

(57) ABSTRACT

An optical modulator includes: a substrate; an optical waveguide layer having Mach-Zehnder waveguides including a first ridge waveguide and a second ridge waveguide for propagating visible light, which are aligned in parallel, and is made of lithium niobate; signal electrodes that include interaction parts disposed along the Mach-Zehnder waveguides; first ground electrodes and second ground electrodes; signal electrode extraction parts that connect the signal electrodes to pads disposed at an end side part; and an optical coupling part that is disposed on a downstream side of the Mach-Zehnder waveguides and couples a plurality of visible light beams, in which the first ground electrodes, the second ground electrodes, and the signal electrode extraction parts are disposed at positions at which the first ground electrodes and the second ground electrodes, and the signal electrode extraction parts are disposed such that they do not overlap with the optical coupling part in plan view.

### CROSS-REFERENCES TO RELATED APPLICATIONS

This application relies for priority upon Japanese Patent Application No. 2024-176250 filed on Oct. 8, 2024, the entire content of which is hereby incorporated herein by reference for all purposes as if fully set forth herein.

### BACKGROUND

The present disclosure relates to an optical modulator, a light source module, an optical engine, and XR glasses.

In recent years, light source modules including optical modulators to which light is input from laser diodes (semiconductor lasers) have attracted attention. Such light source modules can be used as optical engines for glasses-type terminals like XR glasses such as augmented reality (AR) glasses and virtual reality (VR) glasses, small-sized projectors, and the like.

For example, Patent Document 1 describes an image display device that includes a light source unit that outputs first light and second light, an optical modulator that includes a modulation unit of a Mach-Zehnder modulation scheme, and an optical scanner that spatially scans the first light and the second light modulated by the optical modulator. Also, Patent Document 1 describes a head-mount display adapted to be mounted on a user's head as an image display device.

Also, Patent Document 2 describes a transmission device that includes a laser light source that outputs visible light and an optical modulator that changes an intensity of the visible light and generates a visible light signal although this device is not an image display device. Patent Document 2 describes a Mach-Zehnder optical modulator that includes a substrate, an optical waveguide layer, a buffer layer, and an electrode layer, in which the optical waveguide layer is constituted by a lithium niobate film. Also, Patent Document 2 discloses using the electrode layer for the optical modulator including a first signal electrode, a second signal electrode, a first ground electrode, a second ground electrode, and a third ground electrode. The optical modulator disclosed in Patent Document 2 is a so-called dual-drive optical modulator that includes two signal electrodes.

### PATENT DOCUMENTS

[Patent Document 1] Japanese Patent No. 6728596
[Patent Document 2] Japanese Unexamined Patent Application, First Publication No. 2022-036928

### SUMMARY

Patent Document 1 discloses, as a preferred aspect, an aspect in which a single crystal or a solid solution crystal of lithium niobate is used and a part obtained by modifying a portion thereof by a proton exchange method or a Ti diffusion method is used as an optical waveguide. However, since the size of a modified waveguide part (core) region is defined by the distance by which protons and Ti have entered and have been diffused, it is difficult to reduce the diameter of the optical waveguide. Therefore, the optical waveguide itself increases in size, and it is difficult for an electric field of a modulation voltage to concentrate due to the large diameter of the optical waveguide, and it is necessary to apply a large voltage for modulation, or it is necessary to elongate an electrode to which a voltage is applied in order to achieve an operation with a small voltage, which leads to an increase in element size.

In order to widely distribute glasses-type image display device such as XR glasses, size reduction and a decrease in drive voltage are essential. Furthermore, the glasses-type image display devices have to be able to be manufactured at the lowest possible cost for mass production.

A glasses-type image display device like XR glasses forms one image by sequentially scanning each pixel with a laser beam (LB). For example, high-speed modulation of about 1 GHz is needed to obtain a pixel resolution of 2560×1460. Furthermore, 4K corresponds to 3840× 2160, which requires high-speed driving of equal to or greater than 1 GHz.

The present disclosure was made in view of the above problem, and an object thereof is to provide an optical modulator and a light source module of visible light that have small sizes and allow for high-speed driving with low voltages, and an optical engine and XR glasses mounting the same.

In order to solve the above problem, the present disclosure provides the following mechanism.

According to an aspect of the present disclosure, there is provided an optical modulator including: a substrate; an optical waveguide layer that is formed on the substrate, includes a plurality of Mach-Zehnder waveguides including a first ridge waveguide and a second ridge waveguide for propagating visible light aligned in parallel, and is made of lithium niobate; a buffer layer that is formed on the optical waveguide layer; a plurality of signal electrodes that are formed on the buffer layer and include interaction parts disposed along the plurality of Mach-Zehnder waveguides, respectively, and a plurality of first ground electrodes and a plurality of second ground electrodes that are disposed on both sides of each of the plurality of signal electrodes to be separated from the signal electrodes, the signal electrodes being disposed above the first ridge waveguide, the second ground electrodes being disposed above the second ridge waveguide; signal electrode extraction parts that connect the signal electrodes to pads disposed at an end side part of the substrate; an optical coupling part that is disposed on a downstream side of the plurality of Mach-Zehnder waveguides and couples a plurality of visible light beams that have passed through the plurality of Mach-Zehnder waveguides; a plurality of connection waveguides that connect a downstream side of each of the plurality of Mach-Zehnder waveguides to the optical coupling part; and one output waveguide that is connected to the optical coupling part, in which the first ground electrodes, the second ground electrodes, and the signal electrode extraction parts are disposed at positions at which the first ground electrodes, the second ground electrodes, and the signal electrode extraction parts do not overlap with the optical coupling part in plan view.

According to a second aspect of the present disclosure, the number of Mach-Zehnder waveguides is three or more, the number of the plurality of signal electrodes is three or more, the three or more interaction parts included in the signal electrodes, respectively, are parallel to each other in plan view and are aligned in an ascending order from the shortest one, the optical coupling part is disposed closely to a downstream side of a signal electrode having the shortest interaction part from among the plurality of signal electrodes, the number of the plurality of signal electrode extraction parts is three or more, and each of two or more signal electrode extraction parts from among the plurality of signal electrode extraction parts extends so as not to intersect others in a direction of equal to or less than 90° with respect to a direction in which the interaction parts extend from downstream ends of the interaction parts, crosses the plurality of connection waveguides in plan view, and is connected to a pad disposed at an end side part located closely to a downstream side of a signal electrode having the longest interaction part, in the optical modulator according to the first aspect.

According to a third aspect of the present disclosure, higher-order mode removal parts configured to remove higher-order modes are included at a waveguide before branching to the first ridge waveguide and the second ridge waveguide on an upstream side of each of the plurality of Mach-Zehnder waveguides, in the optical modulator according to any one of the first and second aspects.

According to a fourth aspect of the present disclosure, there is provided a light source module including: the optical modulator according to any one of the first to third aspects; and a plurality of light sources that are connected to the plurality of Mach-Zehnder waveguides and output visible light to be input to each of a plurality of input waveguides.

According to a fifth aspect of the present disclosure, there is provided an optical engine including: the light source module according to the fourth aspect; and an optical scanning mirror that reflects light output from the light source module by changing an angle to display an image.

According to a sixth aspect of the present disclosure, there are provided XR glasses including the optical engine according to the fifth aspect mounted thereon.

According to the optical module of the present disclosure, it is possible to provide an optical modulator of visible light that has a small size and allows for high-speed driving with a low voltage.

### BRIEF DESCRIPTION OF THE DRAWINGS

FIG. 1 is a schematic plan view for explaining an example of an optical modulator according to an embodiment.

FIG. 2 is a diagram illustrating the three locations surrounded by dotted line frames illustrated in FIG. 2 in an enlarged manner and a diagram illustrating one of the three enlarged diagrams in a further enlarged manner.

FIG. 3 is a schematic sectional view of the optical modulator according to the present embodiment taken along the line A-A′ illustrated in FIG. 2.

FIG. 4 is a diagram illustrating two locations surrounded by dotted line frames illustrated in FIG. 4 in an enlarged manner.

FIG. 5 is a diagram illustrating two locations surrounded by dotted line frames illustrated in FIG. 5 in an enlarged manner.

FIG. 6 is a diagram for explaining an example in which each of interaction lengths LR, LB, and LG of visible light has been adjusted such that Vπbecomes equal to or less than 2 V.

FIG. 7 illustrates a modification in which positions of a Mach-Zehnder waveguide for blue light and a Mach-Zehnder waveguide for green light have been exchanged in the configuration illustrated in FIG. 6.

FIG. 8A is a diagram for explaining an aspect of coupling of a plurality of visible light beams.

FIG. 8B is a schematic plan view illustrating the vicinity of an optical coupling part 40 indicated by the arrow B in FIG. 8A in an enlarged manner.

FIG. 8C is a schematic plan view illustrating the vicinity of the optical coupling part 40 indicated by the arrow B in FIG. 8A in an enlarged manner.

FIG. 9 is a schematic plan view illustrating the vicinity of higher-order mode removal parts included in the optical modulator according to the present embodiment in an enlarged manner.

FIG. 10 illustrates a schematic plan view of a light source module according to an embodiment of the present disclosure.

FIG. 11 is a part of a schematic sectional view of the light source module illustrated in FIG. 10 taken along a plane XZ, which depicts only a portion of the vicinity of a joint part.

FIG. 12 is a conceptual diagram for explaining an example of XR glasses of the present disclosure.

FIG. 13 is a conceptual diagram illustrating a state where an image is projected directly to retinas by laser light output from a light source module in the XR glasses illustrated in FIG. 12.

### DETAILED DESCRIPTION

Hereinafter, embodiments will be described in detail with reference to the drawings as appropriate. In the drawings used in the following description, characteristic parts may be illustrated in an enlarged manner for easy understanding of features, and dimensional ratios and the like of components may differ from actual dimensional ratios and the like. Materials, dimensions, and the like exemplified in the following description are just examples, and the present disclosure is not limited thereto and can be implemented by appropriately changing them within a scope in which the effect of the present disclosure is achieved.

### Optical Modulator

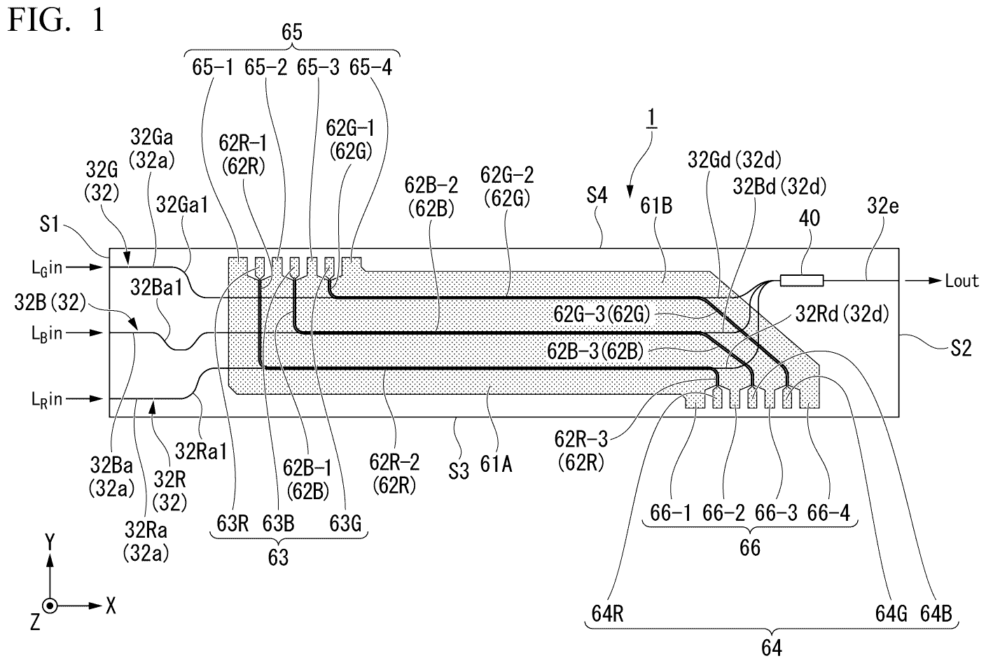

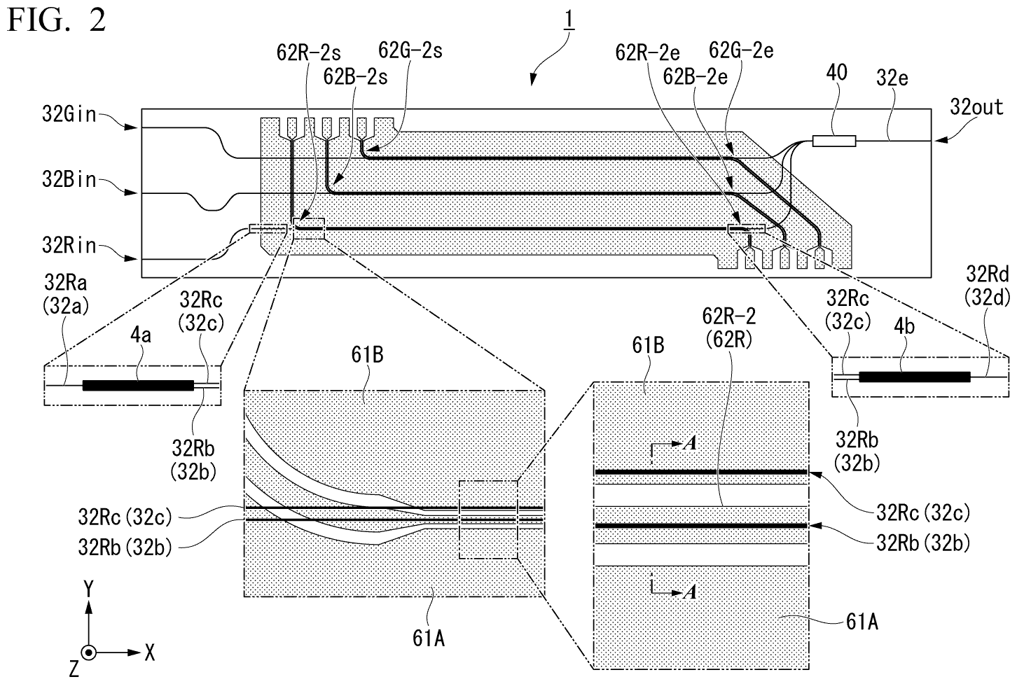

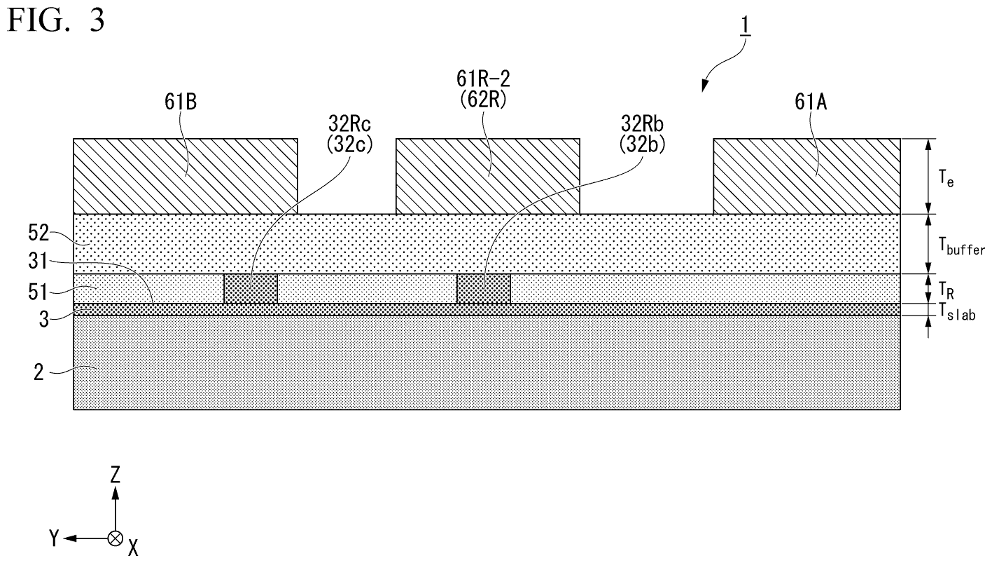

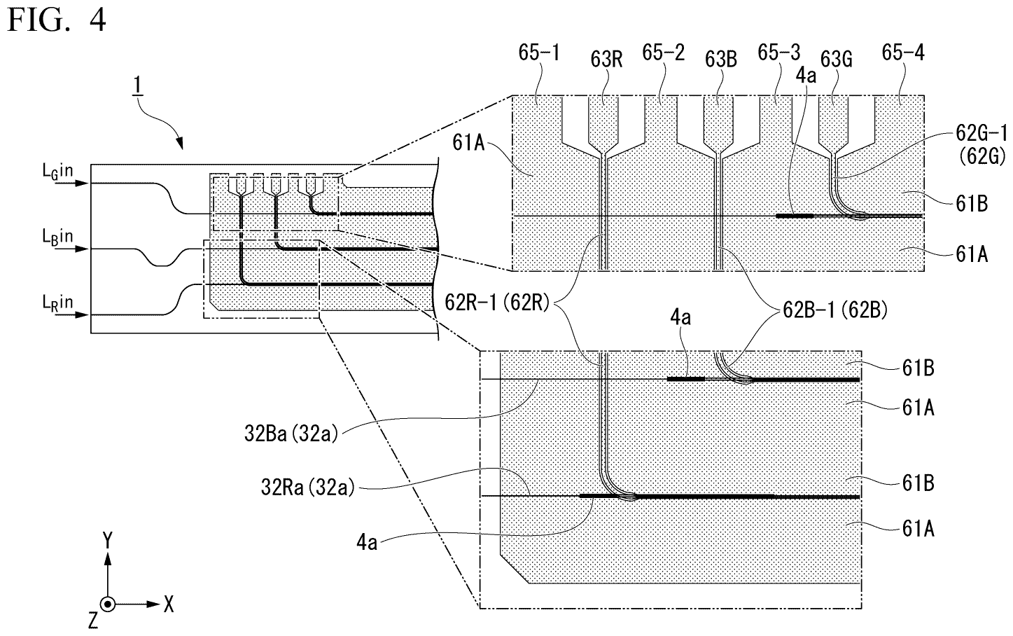

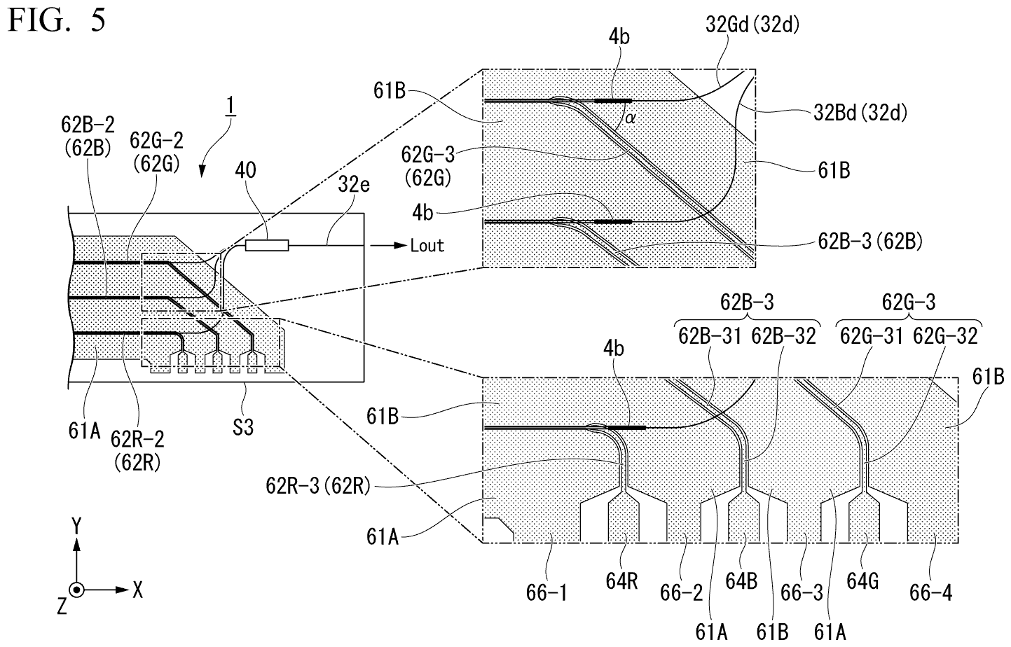

FIG. 1 is a schematic plan view for explaining an example of an optical modulator according to an embodiment of the present disclosure. FIG. 2 is a diagram illustrating three locations illustrated in FIG. 2 in an enlarged manner and a diagram illustrating one of the enlarged diagrams in a further enlarged manner. In the enlarged diagram of FIG. 2, lines that cannot be resolved in the schematic plan view in FIG. 1 are broken down, and the shapes thereof are clearly illustrated. FIGS. 1 and 2 illustrate an optical waveguide structure formed in an optical waveguide layer 3 such that an arrangement relationship between the optical waveguide structure and an electrode structure can be understood. FIG. 3 is a schematic sectional view along the line A-A′ illustrated in FIG. 2. FIG. 4 is a diagram illustrating two locations surrounded by dotted line frames illustrated in FIG. 4 in an enlarged manner. FIG. 5 is a diagram illustrating two locations surrounded by dotted line frames illustrated in FIG. 5 in an enlarged manner.

In FIGS. 1 to 5, the X direction is a direction perpendicularly intersecting a side surface where a light input port is disposed, the Y direction is a direction perpendicularly intersecting the X direction, and the Z direction is a direction perpendicularly intersecting a plane formed by the X direction and the Y direction.

The optical modulator of the present embodiment includes a plurality of Mach-Zehnder (MZI) optical modulation parts and an optical coupling part that couples a plurality of visible light beams that have passed through and modulated by the plurality of Mach-Zehnder optical modulation parts. Hereinafter, a case where the plurality of visible light beams are red light (R), green light (G), and blue light (B) will be described as an example.

An optical modulator 1 illustrated in FIGS. 1 to 5 includes a substrate 2, an optical waveguide layers 3 that is formed on the substrate 2, includes three Mach-Zehnder waveguides 32 (32R, 32B, and 32G) including a first ridge waveguide 32c and a second ridge waveguide 32b for propagating visible light disposed to be aligned in parallel, and is made of lithium niobate, a buffer layer 52 that is formed on the optical waveguide layer 3, a plurality of signal electrodes 62 (62R, 62B, and 62G) formed on the buffer layer 52 and including interaction parts 62R-2, 62G-2, and 62B-2 disposed along each of the plurality of Mach-Zehnder waveguides, and a plurality of first ground electrodes 61A and a plurality of second ground electrodes 61B that are disposed on both sides of each of the plurality of signal electrodes 62 (62R, 62B, and 62G) to be separated from the signal electrodes 62 (62R, 62B, and 62G). As illustrated in the drawings, a configuration in which a first ground electrode and a second ground electrode for one signal electrode serve as a second ground electrode and a first ground electrode for an adjacent signal electrode may be adopted.

The signal electrodes 62 (62R, 62B, and 62G) are disposed above the first ridge waveguide 32c, while the second ground electrode 61B is disposed above the second ridge waveguide 32b.

The substrate 2 and the optical modulator 1 illustrated in FIG. 1 have rectangular shapes in plan view (in a view from the Z direction), and in regard to four sides (lateral sides) of each rectangle, the side on which the visible light is input will be defined as S1, the side facing S1 will be defined as S2, the side on which a waveguide to which visible light with the longest wavelength is guided is disposed out of the sides perpendicularly intersecting S1 and S2 will be defined as S3, and the side facing S3 will be defined as S4 for convenience of explanation. Hereinafter, parts near the side S1, the side S2, the side S3, and the side S4 will be referred to as, for example, an end side part S3 and an end side part S4, and the like.

The optical modulator 1 includes signal electrode extraction parts 62R-1, 62B-1, 62G-1, 62R-3. 62B-3, and 62G-3 that connect the signal electrodes 62 (62R, 62B, and 62G) to pads 63 (63R, 63B, and 63G) and 64 (64R, 64B, 64G) disposed at the end side part S4 and the end side part S3 of the substrate 2, respectively.

Also, the optical modulator 1 includes an optical coupling part 40 that is disposed on the downstream side (the side on which the light is propagated) of the plurality of Mach-Zehnder waveguides 32 (32R, 32B, and 32G) and couples a plurality of visible light beams that have passed through the plurality of Mach-Zehnder waveguides 32 (32R, 32B, and 32G), a plurality of connection waveguides 32d (32Rd, 32Bd, and 32Gd) that connect the downstream side of each of the plurality of Mach-Zehnder waveguides 32 (32R, 32B, and 32G) to the optical coupling part 40, and one output waveguide 32e that is connected to the optical coupling part 40.

In the optical modulator 1, the first ground electrodes 61A, the second ground electrodes 61B, and the signal electrode extraction parts 62R-3, 62B-3, and 62G-3 are disposed at positions at which they do not overlap with the optical coupling part 40 in plan view.

In the optical modulator 1, light of each color generated from each of light sources of a red color (R), a blue color (B), and a green color (G) is input from light input ports 32Rin, 32Bin, and 32Gin (see FIG. 2), the light of each color is optically modulated, the light of the three colors is coupled by the optical coupling part 40, and the coupled light is output from a light output port 32out (see FIG. 2).

Although FIGS. 1 to 5 illustrate a case of the optical modulator 1 with the three Mach-Zehnder waveguides 32, the number of Mach-Zehnder waveguides 32 is not limited to three and may be any number that is two or more.

Positional relationship of first ground electrodes, second ground electrodes, signal electrode extraction parts, and optical coupling part

The optical modulator of the present embodiment is configured such that the first ground electrodes, the second ground electrodes, and the signal electrode extraction parts are disposed at positions at which they do not overlap with the optical coupling part in plan view. Although the example will be described below on the basis of the drawings, such a configuration is not limited to this example.

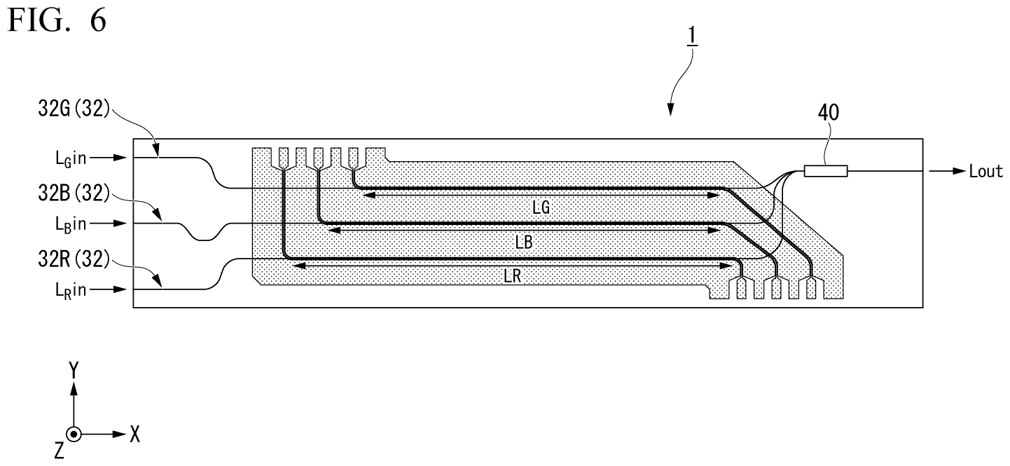

In the optical modulator 1, the three signal electrodes 62R, 62B, and 62G are aligned such that the interaction parts 62R-2, 62B-2, and 62G-2 included therein, respectively, are parallel with each other and are aligned in an ascending order of their lengths from the shortest one (LG<LB<LR (see FIG. 6)) in plan view. In other words, the three signal electrodes 62R, 62B, and 62G are disposed such that the signal electrode 62B is disposed next to the signal electrode 62G and the signal electrode 62R is disposed next to the signal electrode 62B.

As illustrated in an enlarged manner in the enlarged view of FIG. 4, the pads 63R, 63B, and 63G for the three signal electrode extraction parts 62R-1, 62B-1, and 62G-1 disposed at the end side part S4 of the substrate 2 are disposed in order from the upstream side (the side on which light is input) to the downstream side (the side on which the light is propagated) (+x direction). The signal electrode extraction parts 62R-1, 62B-1, and 62G-1 extend in a direction substantially perpendicularly intersecting the direction (x direction) in which the interaction parts 62R-2, 62B-2, and 62G-2 extend, from the three pads 63R, 63B, and 63G, respectively. The positions (coordinates) of upstream ends 62R-2s, 62B-2s, and 62G-2s of the interaction parts 62R-2, 62B-2, and 62G-2 in the x direction are located in this order on the downstream side.

At the end side part S3 of the substrate 2, pads 65-1, 65-2, 65-3, and 65-4 of the first ground electrodes 61A and the second ground electrodes 61B are disposed such that they are alternately aligned with the pads 63R, 63B, and 63G for the signal electrode extraction parts 62R-1, 62B-1, and 62G-1.

In the optical modulator 1, the positions (coordinates) of downstream ends 62R-2e, 62B-2e, and 62G-2e (see FIG. 2) of the interaction parts 62R-2, 62B-2, and 62G-2 in the x direction are substantially aligned (aligned substantially on one straight line in the y direction). The configuration in which the positions (coordinates) of the downstream ends 62R-2e, 62B-2e, and 62G-2e in the x direction are substantially aligned can be adopted regardless of the positions (coordinates) of the upstream ends 62R-2s, 62B-2s, and 62G-2s of the interaction parts 62R-2, 62B-2, and 62G-2 in the x direction being located in this order on the downstream side because the interaction part 62R-2 for red light may be shorter than the interaction part 62B-2 for blue light and the interaction part 62G-2 for green light (LG<LB<LR (see FIG. 6)). The present disclosure is not limited to the case where the positions (coordinates) of the downstream ends 62R-2e, 62B-2e, and 62G-2e of the interaction parts 62R-2, 62B-2, and 62G-2 in the x direction are aligned substantially on one straight line in the y direction, and the positions (coordinates) of the downstream ends 62R-2e, 62B-2e, and 62G-2e in the x direction are preferably within 20% of the length LR of the interaction part 62R-2, are more preferably within 15% of the length LR of the interaction part 62R-2, and are further preferably within 10% of the length LR of the interaction part 62R-2.

All of the three signal electrode extraction parts 62R-3, 62B-3, and 62G-3 are bent at a predetermined angle α (see FIG. 5) with respect to the direction (x direction) in which the interaction parts 62R-2, 62B-2, and 62G-2 extend from the downstream ends 62R-2e, 62B-2e, and 62G-2e (see FIG. 2) of the interaction parts 62R-2, 62B-2, and 62G-2, extend such that the three signal electrode extraction parts 62R-3, 62B-3, and 62G-3 do not intersect one another, cross the three connection waveguides 32Rd, 32Bd, and 32Gd in plan view, and are connected to the pads 64 (64R, 64B, and 64G) disposed at the end side part 2B located closely to the downstream side of the signal electrode having the longest interaction part, that is, the signal electrode 62R. The angle α is an angle that is equal to or less than 90°, and in the illustrated example, the angle α of the signal electrode extraction parts 62B-3 and 62G-3 is about 45°, while the angle α of the signal electrode extraction part 62R-3 is 90°. It is possible to further shorten the length (the length from S1 to S2) of the optical modulator 1 as the angle α becomes greater, and the angle α is thus preferably equal to or greater than 30°. In regard to the angle α of the plurality of signal electrode extraction parts, a configuration in which the angle α of one signal electrode extraction part is 90° while the angle α of the other signal electrode extraction parts is less than 90° or a configuration in which the angle α of all the signal electrode extraction parts is less than 90° is preferable. In a case of three signal electrode extraction parts, for example, a configuration in which the angle α of one signal electrode extraction part is 90° while the angle α of the remaining two signal electrode extraction parts is less than 90° or a configuration in which the angle α of all the three signal electrode extraction part is less than 90° is preferable. It is possible to shorten the length (the distance from S1 to S2) of the optical modulator 1 to the maximum extent when the signal electrode extraction part 62R-3 is bent at 90° and the signal electrode extraction part 62B-3 and the signal electrode extraction part 62G-3 are bent at an angle of less than 90°.

More specific description will be given using the enlarged view of FIG. 5.

In the illustrated example, the signal electrode extraction part 62G-3 and the signal electrode extraction part 62B-3 include parts 62G-31 and 62B-31 that are bent at the same angle α at the downstream ends 62G-2e and 62B-2e and extend in parallel to the direction of the angle α, and parts 62G-32 and 62B-32 that are further bent and extend toward the end side part S3. On the other hand, the signal electrode extraction part 62R-3 includes only a part that is bent at a predetermined angle and extends toward the end side part S3. The signal electrode extraction part 62R-3 is parallel to the part 62G-32 of the signal electrode extraction part 62G-3 and the part 62B-32 of the signal electrode extraction part 62B-3.

The three signal electrode extraction parts 62R-3, 62B-3, and 62G-3 can be disposed in this manner because the interaction part 62R-2 for red light can be shorter than the interaction part 62B-2 for blue light and the interaction part 62G-2 for green light (LG<LB<LR (see FIG. 6)).

In addition, the optical coupling part 40 is disposed to be close to the downstream side of the signal electrode with the shortest interaction part, that is, the signal electrode 62G from among the three signal electrodes 62R, 62B, and 62G. In other words, the optical coupling part 40 is disposed to be located most closely to the signal electrode 62G, the second most closely to the signal electrode 62B, and the furthest from the signal electrode 62R.

The configuration in which the positions (coordinates) of the bent positions of the three signal electrode extraction parts 62R-3, 62B-3, and 62G-3 (corresponding to the positions of the downstream ends 62R-2e, 62B-2e, and 62G-2e of the interaction parts 62R-2, 62B-2, and 62G-2) in the x direction are substantially aligned and also the optical coupling part 40 is disposed to be close to the downstream side of the signal electrode 62G ensures the configuration in which the first ground electrodes 61A, the second ground electrodes 61B, and the signal electrode extraction parts 62R-3, 62B-3, and 62G-3 are disposed such that they do not overlap with the optical coupling part 40 in plan view. This is for preventing an effective refractive index of lithium niobate forming the optical coupling part from changing and curbing a loss due to deviation from a designed value with the configuration in which the first ground electrodes, the second ground electrodes, and the signal electrode extraction parts are not disposed above the optical coupling part.

It is possible to prevent the effective refractive index of lithium niobate forming the optical coupling part from changing and to curb a loss due to deviation from the designed value not only by the shapes and the arrangement of the first ground electrodes, the second ground electrodes, and the signal electrode extraction parts described in the present embodiment but also by any configuration in which the first ground electrodes, the second ground electrodes, and the signal electrode extraction parts are not disposed above the optical coupling part.

As illustrated in the enlarged view of FIG. 4, the Mach-Zehnder waveguides and the signal electrode extraction parts are preferably disposed such that each of the signal electrode extraction parts 62R-1, 62B-1, and 62G-1 does not overlap with a light branching part 4a of each Mach-Zehnder waveguide in plan view. This is for preventing the effective refractive index of lithium niobate forming the optical branching part from changing and curbing a loss due to deviation from a designed value by adopting the configuration in which the signal electrode extraction parts with electrical signals passing therethrough are not disposed above the optical branching part.

As illustrated in the enlarged view of FIG. 5, the Mach-Zehnder waveguides and the signal electrode extraction parts are preferably disposed such that each of the signal electrode extraction parts 62R-3, 62B-3, and 62G-3 does not overlap with an optical coupling part 4b of each Mach-Zehnder waveguide in plan view. This is for preventing the effective refractive index of lithium niobate forming the optical coupling part from changing and curbing a loss due to deviation from a designed value by adopting the configuration in which the signal electrode extraction part with an electrical signal passing therethrough is not disposed above the optical coupling part.

The optical modulator of the present embodiment has a small size and can be driven with a low voltage. In order to evaluate size reduction and driving with a low voltage, it is possible to use VπL. Vπ is a voltage (half-wavelength voltage) necessary for phase modulation of a half-wavelength and is defined by a difference between a voltage V₁ leading to the maximum optical output and a voltage V₂ leading to the minimum optical output. Also, L is a length (an interaction length, an electrode length) of the part (interaction part) of the signal electrode overlapping with the optical waveguide (ridge). The half-wavelength voltage Vπdecreases as the interaction length L increases, and the half-wavelength voltage Vπincreases as the interaction length L decreases. In order to reduce the size of the optical modulator, the interaction length L is shortened, and the half-wavelength voltage Vπ is increased.

Smaller VπL indicates a smaller size and a lower drive voltage. Hereinafter, VπL may be referred to as field efficiency.

In the case of the example of the present embodiment, an example in which the interaction lengths LR, LB, and LG of the visible light are adjusted such that Vπbecomes equal to or less than 2 V for red light with a peak wavelength of 637 nm, green light with a peak wavelength of 520 nm, and blue light with a peak wavelength of 455 nm will be described using FIG. 6. If Vπ is equal to or less than 2 V, driving can be achieved by using a CMOS.

The Interaction lengths LR, LB, and LG and the half-wavelength voltage Vπ are shown in Table 1. The interaction lengths LB and LG for green light and blue light are shortened to shorten the length of the optical modulator.

TABLE 1

| Wavelength [nm] | VπL [Vcm] | L [cm] | Vπ [V] |
|---|---|---|---|
| 637 | 0.95 | 0.50 | 1.9 |
| 520 | 0.74 | 0.41 | 1.8 |
| 455 | 0.61 | 0.45 | 1.4 |

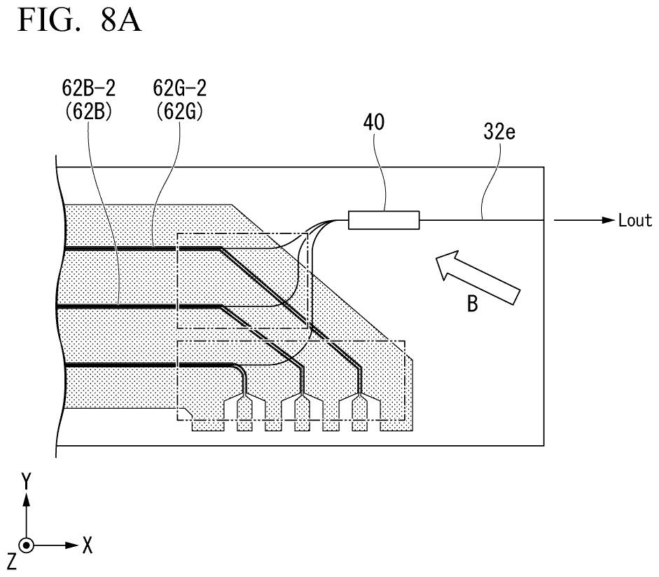

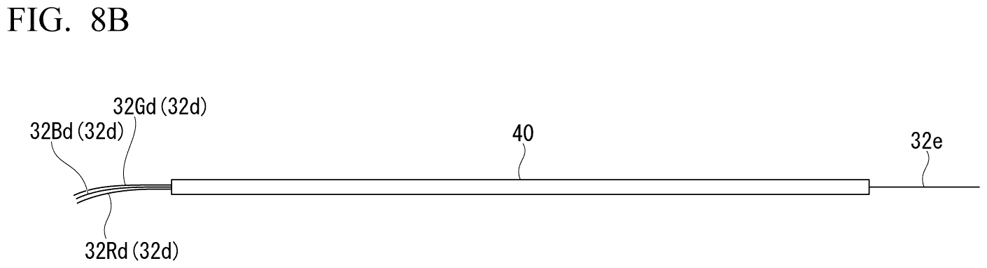

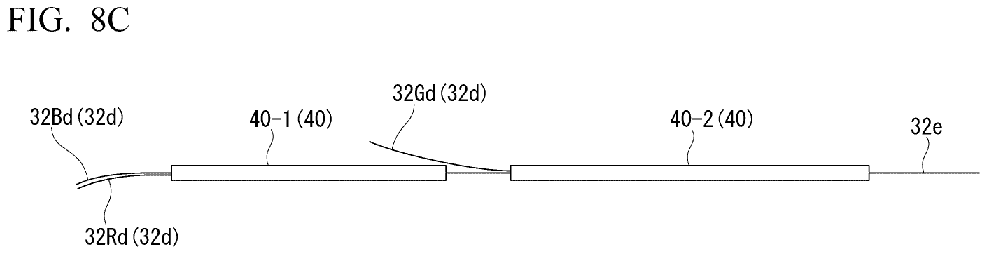

In the example shown in FIG. 6 and Table 1, a configuration in which three-input one-output (3×1) optical coupling part is used as the optical coupling part 40 as illustrated in FIG. 8B, which will be described later, to simultaneously couple three visible light beams (red light, blue light, and green light) with different wavelength input from the three connection waveguides 32Rd, 32Bd, and 32Gd and output them as one coupled light beam to the output waveguide 32e is preferable as an aspect for coupling three visible light beams.

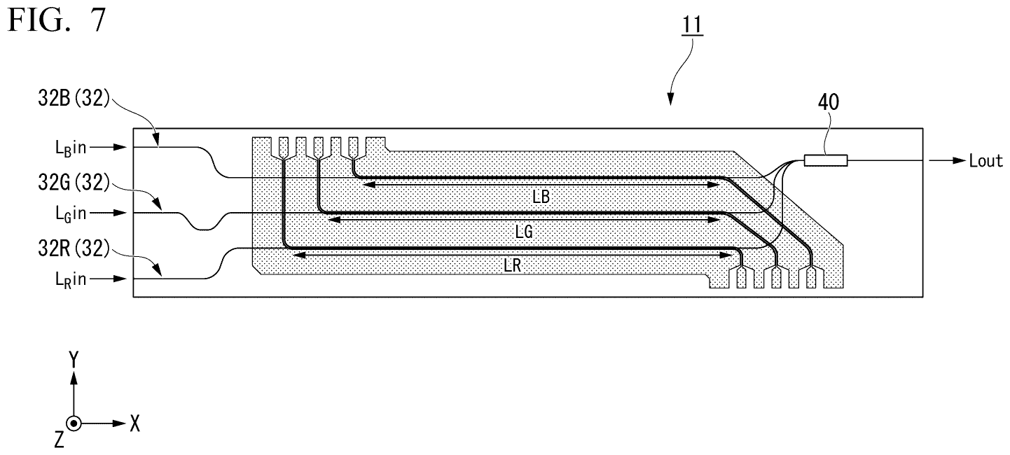

FIG. 7 illustrates a modification in which the positions of the Mach-Zehnder waveguide 32B for blue light and the Mach-Zehnder waveguide 32G for green light are exchanged in the configuration illustrated in FIG. 6.

In this modification, an example in which the interaction lengths LR, LB, and LG of the visible light are adjusted such that Vπbecomes equal to or less than 2 V will be described.

The interaction lengths LR, LB, and LG and the half-wavelength voltage Vπ are shown in Table 2. Similarly, the interaction lengths LB and LG for green light and blue light are shortened to shorten the length of the optical modulator.

TABLE 2

| Wavelength [nm] | VπL [Vcm] | L [cm] | Vπ [V] |
|---|---|---|---|
| 637 | 0.95 | 0.50 | 1.9 |
| 520 | 0.74 | 0.45 | 1.6 |
| 455 | 0.61 | 0.41 | 1.5 |

In the example illustrated in FIG. 7 and Table 2, a configuration in which two two-input one-output (2×1) optical coupling parts 40-1 and 40-2 are used as optical coupling parts 40 as illustrated in FIG. 8C, which will be described later, the optical coupling part 40-1 couples two visible light beams (red light and green light) with different wavelengths input from the two connection waveguides 32Rd and 32Gd first, and the optical coupling part 40-2 then couples the coupled light with visible light (blue light) input from the connection waveguide 32Bd and outputs them as one coupled light to the output waveguide 32e is preferable as an aspect of coupling three visible light beams.

### High-Speed Modulation

4K corresponds to 3840×2160, and high-speed driving (high-speed modulation) of equal to or greater than 1 GHz is needed. Modulation by the optical modulator of the present embodiment is voltage control, higher-speed modulation as compared with modulation of current control by a laser light source can be achieved, and high-speed driving (high-speed modulation) of equal to or greater than 1 GHz can be achieved since the optical waveguide layer is a film made of lithium niobate. A designed band for the optical modulator according to the present embodiment is 10 GHz.

### Substrate 2

The substrate 2 may be any substrate with a lower refractive index than the lithium niobate film forming the optical waveguide layer 3 and is not particularly limited, and examples thereof include a sapphire substrate, an SI substrate, and a thermal silicon oxide substrate. The substrate 2 is preferably one that allows the lithium niobate film to be formed as an epitaxial film.

Since the optical waveguide layer is made of a lithium niobate (LiNbO₃) film, the substrate that allows a single-crystal lithium niobate film to form as an epitaxial film is preferably a sapphire single-crystal substrate or a silicon single-crystal substrate although the substrate 2 is not particularly limited as long as it has a lower refractive index than the lithium niobate film. Although a crystal orientation of the single-crystal substrate is not particularly limited, a lithium niobate film with a c-axis orientation has three-fold symmetry, for example, it is thus desirable that a single-crystal substrate of a base layer also have the same symmetry, and a c-plane substrate and a (111)-plane substrate are preferable in the case of a sapphire single-crystal substrate and the silicon single-crystal substrate, respectively.

### Optical Waveguide Layer 3

The optical waveguide layer 3 is made of a lithium niobate film. Lithium niobate forming the lithium niobate film may contain elements other than lithium (Li), niobium (Nb), and oxygen (O).

Lithium niobate may be a compound represented by Formula (I), for example.

LixNbAyOz (I)

(In Formula (I), A represents an element other than Li, Nb, and O. x represents a number that is equal to or greater than 0.5 and equal to or less than 1.2. y represents a number that is equal to or greater than 0 and equal to or less than 0.5. z represents a number that is equal to or greater than 1.5 and equal to or less than 4.0.)

In Formula (I), A may be an element other than Li, Nb, and O, and examples thereof can include K, Na, Rb, Cs, Be, Mg, Ca, Sr, Ba, Ti, Zr, Hf, V, Cr, Mo, W, Fe, Co, Ni, Zn, Sc, and Ce. A may be only one kind selected from these elements or may be two or more kinds.

In Formula (I), x is a number that is equal to or greater than 0.5 and equal to or less than 1.2, and is preferably a number that is equal to or greater than 0.9 and equal to or less than 1.05. y is a number that is equal to or greater than 0 and equal to or less than 0.5. z is a number that is equal to or greater than 1.5 and equal to or less than 4.0, and is preferably a number that is equal to or greater than 2.5 and equal to or less than 3.5

The lithium niobate film forming the optical waveguide layer 3 is preferably an epitaxial film.

The lithium niobate film is, for example, a c-axis oriented lithium niobate film. The lithium niobate film is, for example, an epitaxial film that has epitaxially grown on the substrate 2. The epitaxial film is a single-crystal film with a crystal orientation aligned by the substrate as a base layer. The epitaxial film is a film with a single crystal orientation in the z direction and the xy in-plane direction, and the crystal are oriented to be aligned in all the x-axis, y-axis, and z-axis directions. Whether the film formed on the substrate 2 is an epitaxial film can be proved by checking peak intensity at an orientation position in 2θ-θ X-ray diffraction and a pole, for example.

The optical waveguide layer 3 includes a plurality of flat parts 31 and ridges 32 that are disposed between adjacent flat parts 31 and have a shape projecting in a strip shape from the flat parts 31. In the optical modulator 1 of the present embodiment, an input waveguide 32a, which will be described later, the light branching part 4a, the first ridge waveguide 32c branched from the input waveguide 32a, the second ridge waveguide 32b, the optical coupling part 4b at which these are coupled, and an output waveguide 32d will be collectively referred to as one ridge 32.

The number n of ridges 32 is an integer that is equal to or greater than 2. FIGS. 1 to 5 illustrates an example of three (n=3). Visible light with different wavelengths is input to each of the three ridges 32R, 32G, and 32B.

In the present embodiment, red light with a peak wavelength of equal to or greater than 610 nm and equal to or less than 750 nm is input to the ridge 32R, for example. Green light with a peak wavelength of equal to or greater than 500 nm and equal to or less than 560 nm is input to the ridge 32G, for example. Blue light with a peak wavelength of equal to or greater than 435 nm and equal to or less than 480 nm is input to the ridge 32B, for example. The optical modulator 1 of the present embodiment can be preferably used for XR glasses capable of displaying full-color images, for example, since the three ridges 32R, 32G, and 32B are adapted such that red light, green light, and blue light are input thereto, respectively.

Each of the three ridges 32R, 32G, and 32B includes the input waveguide 32a, the light branching part 4a, the first ridge waveguide 32c, the second ridge waveguide 32b, the optical coupling part 4b, and the output waveguide 32d.

In the three ridges 32R, 32G, and 32B of the optical waveguide layer 3, the input waveguide 32a has a substantially rectangular shape in a sectional view, for example, and visible light generated by a light source such as a laser element is input thereto. The input waveguide 32a is branched into the first ridge waveguide 32c and the second ridge waveguide 32b at the light branching part 4a. The first ridge waveguide 32c and the second ridge waveguide 32b may have trapezoidal shapes in a sectional view, for example. The first ridge waveguide 32c and the second ridge waveguide 32b in the present embodiment have the same shape in a sectional view. The first ridge waveguide 32c and the second ridge waveguide 32b are coupled as the output waveguide 32d by the optical coupling part 4b. The output waveguide 32d has a substantially rectangular shape in a sectional view, for example, and outputs a visible light signal generated by the optical coupling part 4b.

The sectional shapes of the input waveguide 32a and the output waveguide 32d are not limited to the rectangular shapes, and may be, for example, trapezoidal shapes or semicircular shapes.

Also, the sectional shapes of the first ridge waveguide 32c and the second ridge waveguide 32b are not limited to the trapezoidal shapes, and may be, for example, rectangular shapes or semicircular shapes.

Moreover, the sectional shapes of the input waveguide 32a, the output waveguide 32d, the first ridge waveguide 32c, and the second ridge waveguide 32b may have symmetry or may not have symmetry.

In a case where the optical modulator of the present embodiment is used for a glasses-type image display device, the thickness (T_{slab}) of the flat parts 31 of the optical waveguide layer 3 is preferably 0.1 μm to 0.3 μm, and the thickness (T_{R}) of the ridges 32 of the optical waveguide layer 3 is preferably 0.5 μm to 1.0 μm.

This is because light is not propagated when the thickness (T_{R}) of the ridges 32 is thin while the propagating light is brought into multiple modes when the thickness is thick.

In the case where the optical modulator of the present embodiment is used for a glasses-type image display device, the distance(S) between centers of the ridges 32 is preferably 2 μm to 12 μm.

This is because it is possible to shorten the distance between the signal electrodes and the ground electrodes and to enhance field efficiency to be imparted to the ridges 32 by reducing S.

The ridges 32b and 32c illustrated in FIG. 3 can have trapezoidal shapes that are symmetric with respect to the center line.

In the case where the optical modulator of the present embodiment is used for a glasses-type image display device, an inclination angle (α) of the ridges 32b and 32c is preferably 60 degrees to 90 degrees in the case of these shapes. This is because the propagating light is brought into multiple modes when the inclination angle is small.

Moreover, a width (W_{R}) of upper surfaces of the ridges 32b and 32c is preferably 0.3 μm to 1.2 μm.

This is because light is not propagated when the waveguide width is small while the propagating light is brought into multiple modes when the waveguide width is large.

As the optical coupling part 40, an optical coupling part with a known configuration can be used. For example, it is possible to use a multi-mode interferometer (MMI) coupler, a Y-shaped coupler, a directional coupler or the like.

### Protective Layer 51

A protective layer 51 is disposed between the flat parts 31 of the optical waveguide layer 3 and the buffer layer 52 as illustrated in FIG. 3. The protective layer 51 is made of a dielectric body with a smaller refractive index than the optical waveguide layer 3. Examples of a material of the protective layer 51 that can be used include silicon oxide (SiO₂), aluminum oxide (Al₂O₃), lanthanum oxide (La₂O₃), and a composite of these oxides. Examples of the composite of the oxides include LaAlSiInO. As a material of the protective layer 51, it is preferable to use silicon oxide (SiO₂) among the above examples.

### Buffer Layer 52

The buffer layer 52 is formed on the optical waveguide layer 3 and the protective layer 51 and prevents visible light propagated through the optical waveguide layer 3 from being absorbed by an electrode layer.

The buffer layer 52 is made of a dielectric body with a lower refractive index than the optical waveguide layer 3.

The dielectric constant of the dielectric body constituting the buffer layer 52 is preferably equal to or greater than 7. This is because the field efficiency VπL can be reduced.

Examples of a specific material of the buffer layer 52 include aluminum oxide (Al₂O₃, dielectric constant: 7) and LaAlSiInO (dielectric constant: 11).

The material of the buffer layer 52 may be the same material as that of the protective layer 51 or may be a different material therefrom.

The thickness (T_{buffer}) of the buffer layer 52 is preferably equal to or greater than 0.4 μm and equal to or less than 1 μm. This is because the field efficiency VπL can be reduced.

### Electrode Layer

As the electrode layer, one signal electrode 62 that is formed on the buffer layer 52 and the first ground electrodes 61A and the second ground electrodes 61B disposed on both sides of the signal electrode 62 are included.

The optical modulator of the present embodiment is a so-called single-driving optical modulator including one signal electrode. A so-called dual-driving optical modulator including two signal electrodes has a complicated electrode structure, is required to apply electric signals with inverted data to the two signal electrodes while controlling the phases thereof, and thus has a problem that a circuit configuration of a drive system becomes complicated. The optical modulator of the present embodiment is of a single-driving type and therefore, does not have such a problem.

In the case where the optical modulator of the present embodiment is used for a glasses-type image display device, the width (We) of the signal electrode 62 is preferably 1.0 μm to 4.0 μm.

This is because the field efficiency VπL can be reduced.

In the case where the optical modulator of the present embodiment is used for a glasses-type image display device, the widths of the first ground electrodes 61A and the second ground electrodes 61B are preferably 50 μm to 1000 μm.

This is because the voltage does not become 0 V and the field efficiency VπL increases when the ground electrodes are thin.

In the case where the optical modulator of the present embodiment is used for a glasses-type image display device, the thickness (Te) of the electrode layer is preferably 0.1 μm to 5 μm.

This is because microwaves are propagated with higher efficiency as the electrode sectional area increases when a modulation frequency is high.

In the case where the optical modulator of the present embodiment is used for a glasses-type image display device, the distance (G) between the signal electrode 62 and the ground electrodes 61 is preferably 1 μm to 12 μm.

This is because the field efficiency VπL can be reduced.

### Aspect of Coupling of a Plurality of Visible Light Beams

FIGS. 8A to 8C are diagrams for explaining an aspect of coupling of a plurality of visible light beams.

The drawings illustrated in FIGS. 8B and 8C are schematic plan views illustrating the vicinity of the optical coupling part 40 indicated by the arrow B in FIG. 8A in an enlarged manner.

In the aspect illustrated in FIG. 8B, a three-input one-output (3× 1) optical coupling part is used as the optical coupling part 40, and three visible light beams (red light, blue light, and green light) with different wavelengths input from the three connection waveguides 32Rd, 32Bd, and 32Gd are simultaneously coupled and are output as one coupled light beam to the output waveguide 32e. Even in a case where the number of visible light beams, which is three here, is a number (n) that is equal to or greater than two and other than three, it is possible to similarly use n-input one-output (n×1) optical coupling part to simultaneously couple n visible light beams to thereby obtain one coupled light beam.

The aspect illustrated in FIG. 8C is a case where two two-input one-output (2×1) optical coupling parts 40-1 and 40-2 are used as optical coupling parts 40. The optical coupling parts of this type will be referred to as optical coupling parts of a two-stage configuration. Accordingly, the optical coupling part of the type illustrated in FIG. 8B will be referred to as an optical coupling part of a one-stage configuration.

First, two visible light beams (red light and blue light) with different wavelengths input from the two connection waveguides 32Rd and 32Bd are coupled by the optical coupling part 40-1, and the coupled light and visible light (green light) input from the connection waveguide 32Gd are then coupled by the optical coupling part 40-2 and are output as one coupled light beam to the output waveguide 32e. Although the red light and the blue light are coupled first and the green light is then coupled in the example illustrated in FIG. 8C, combination of the visible light beams to be coupled first and the visible light beams to be coupled thereafter is not limited to this example.

### Higher-Order Mode Removal Parts

The optical modulator of the present embodiment may include higher-order mode removal parts configured to remove higher-order modes in a waveguide before branching into the first ridge waveguide and the second ridge waveguide on the upstream side of each of the plurality of Mach-Zehnder waveguides.

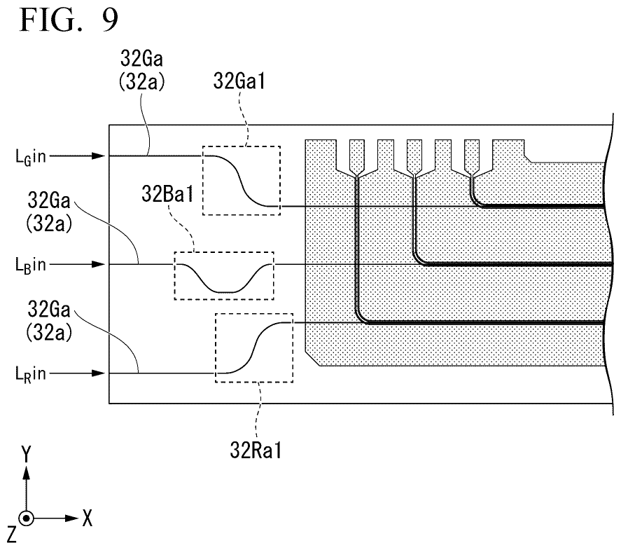

FIG. 9 is a schematic plan view illustrating the vicinity of the higher-order mode removal parts included in the optical modulator 1 in an enlarged manner. The parts surrounded by the dotted line frames are higher-order mode removal parts 32Ra1, 32Bal, and 32Ga1.

The higher-order mode removal parts are sections configured such that a basic mode (zero-order mode (single mode)) passes therethrough with a small loss and higher-order modes (a first-order mode, a second-order mode, . . . (multi-mode)) pass therethrough with a large loss, from among the basic mode and the higher-order modes of each visible light beam.

As a configuration of the higher-order mode removal part, a bent waveguide can be exemplified as illustrated in FIG. 9. Moreover, there is a configuration in which the higher-order modes are removed by setting a line width of the optical waveguide to a predetermined width as another configuration example of the higher-order mode removal parts.

As a configuration of the higher-order mode removal part, a specific dimension example in which the higher-order modes are removed to achieve a single mode will be described in regard to the case of the bent waveguide illustrated in FIG. 9.

It was confirmed through a simulation that the higher-order modes were removed to achieve a single mode when red light with a peak wavelength of 637 nm, green light with a peak wavelength of 520 nm, and blue light with a peak wavelength of 455 nm are used, the width of the optical waveguide is set to the dimension shown in Table 3, and the radius of curvature of the bent waveguide was set to 200 μm.

TABLE 3

| Wavelength [nm] | Waveguide width [μm] |
|---|---|
| 637 | 0.4 |
| 520 | 0.5 |
| 455 | 0.6 |

### Manufacturing Method

The optical modulator 1 of the present embodiment illustrated in FIG. 1 can be manufactured by the method described below, for example.

First, the optical waveguide layer 3 made of a lithium niobate film is formed on the substrate 2.

As a method of forming the lithium niobate film on the substrate 2, it is possible to use, for example, a thin film formation method such as a sputtering method, a CVD method, or a sol-gel method.

In a case where a sapphire single-crystal substrate is used as the substrate 2, a lithium niobate film may be caused to epitaxially grow directly on the sapphire single-crystal substrate.

In a case where a silicon single-crystal substrate is used as the substrate 2, a lithium niobate film may be formed through epitaxial growth via a cladding layer. As the cladding layer, a cladding layer that has a lower refractive index than the lithium niobate film and is suitable for epitaxial growth is used. Specifically, a cladding layer made of Y₂O₃, for example, can be used as the cladding layer. It is possible to form a lithium niobate film with high quality by causing the lithium niobate film to epitaxially grow via the cladding layer made of Y₂O₃ on the silicon single-crystal substrate.

Next, the thus obtained lithium niobate film is pattern-formed into a desired shape using a known method such as a photolithography method. In this manner, the optical waveguide layer 3 including the plurality of flat parts 31 and n ridges 32 disposed between adjacent flat parts 31 is obtained.

Next, the protective layer 51 is formed on the flat parts 31 of the optical waveguide layer 3 using a thin film formation method such as a sputtering method, a CVD method, or a sol-gel method, for example.

Thereafter, the buffer layer 52 is formed to cover the protective layer 51 and the ridges 32 of the optical waveguide layer 3. As a method of forming the buffer layer 52, a known method can be used. Specifically, it is possible to use a thin film formation method such as a sputtering method, a CVD method, or a sol-gel method, for example, as a method of forming the buffer layer 52.

Next, the electrode layer is formed on the buffer layer 52 using a method described below, for example.

First, a metal thin film is formed on the buffer layer 52 using a thin film formation method such as a deposition method, a sputtering method, a CVD method, or a sol-gel method, for example. Then, the metal thin film is pattern-formed into a desired shape using a known method such as a photolithography method. In this manner, the electrode layer including the plurality of first ground electrodes 61A and second ground electrodes 61B with strip shapes in plan view and the plurality of signal electrodes 62 with a strip shape in plan view is formed.

The electrode layer may be formed using a method of forming a metal thin film by a method such as deposition or a sputtering method via a mask with a desired shape. The optical modulator 1 of the present embodiment is obtained through the above processes.

### Light Source Module

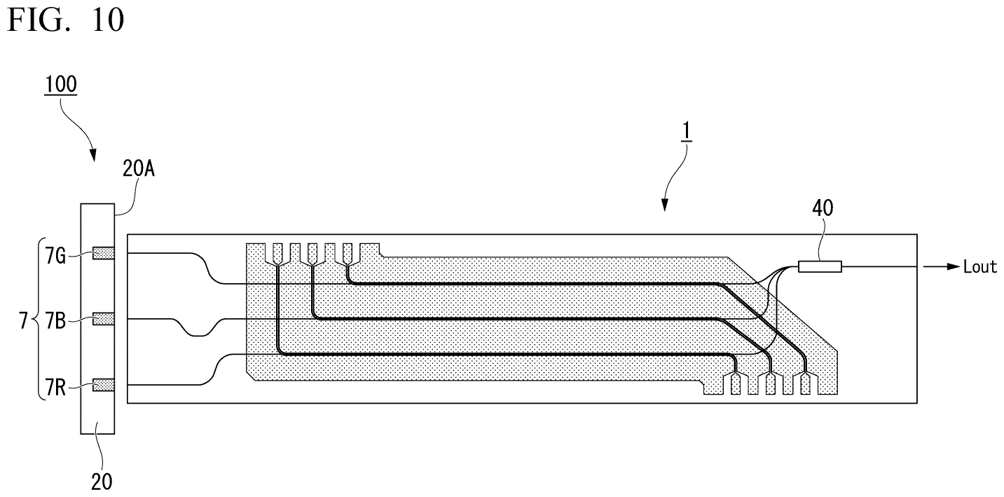

FIG. 10 illustrates a schematic plan view of a light source module according to an embodiment of the present disclosure.

The light source module includes the optical modulator according to the above embodiment and a plurality of light sources that output visible light to be input to each of the plurality of input waveguides of the optical modulator.

A light source module 100 illustrated in FIG. 10 includes three light sources 7R, 7G, and 7B as light sources 7. Each of the light sources 7R, 7G, and 7B outputs visible light to be input to each of the input waveguides 32a included in the Mach-Zehnder waveguides 32 (32R, 32G, and 32B) in the optical waveguide layer 3 of the optical modulator 1. For example, the light source 7R can emit red light, the light source 7G can emit green light, and the light source 7B can emit blue light.

As the light sources 7R, 7G, and 7B, it is possible to use laser elements such as laser diodes (LDs) and to use various commercially available laser elements.

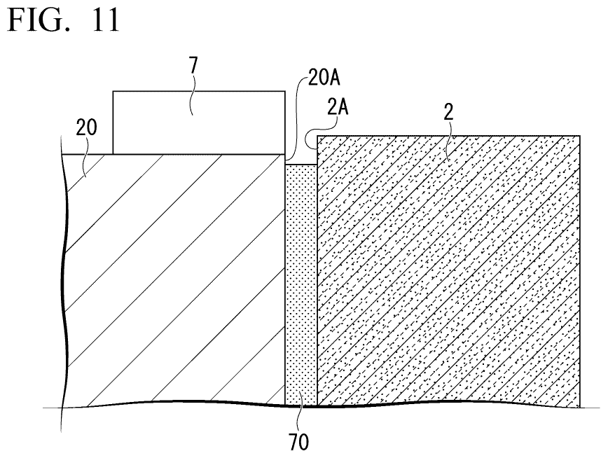

FIG. 11 is a schematic sectional view of a part of the light source module 100 illustrated in FIG. 10 taken along the XZ plane. Only a part in the vicinity of the joint part is depicted.

Each light source 7 is installed on an upper surface of the light source base 20. The light source base 20 may be a common light source base for all the light sources or may be provided as individual light source bases for the respective light sources. The light source base 20 is constituted by, for example, aluminum nitride (AlN), aluminum oxide (Al₂O₃), or silicon (Si).

The light source base 20 and the substrate 2 for optical waveguide with the optical waveguide layer formed thereon can be configured to be joined directly to each other via a metal layer 70. With this configuration, it is possible to further reduce the size by not performing special coupling and fiber coupling.

With the configuration in which a joint surface 20A of the light source base 20 and a joint surface 2A of the substrate 2 for optical waveguide are joined to each other via the metal layer 70, it is possible to align the optical axis position of laser light such that an optical axis of each light source 7 coincides with an axis of the input waveguide by adjusting relative positions of the light source base 20 and the substrate 2 for optical waveguide at the time of manufacturing (active alignment).

The metal layer 70 can be made of a plurality of metal layers.

In a case where the light source module of the present embodiment is used for XR glasses, a gap (interval) S between the joint surface 20A of the light source base 20 and the joint surface 2A of the substrate 2 for optical waveguide is preferably greater than 0 μm and equal to or less than 5 μm, for example, in consideration of a light amount and the like required by the XR glasses.

### Driving Method

The optical modulator can modulate input light into output light with a high-frequency modulation voltage and a DC bias voltage. An operation point Vd of the optical modulator is adjusted by controlling the DC bias voltage Vdc. The operation point Vd is a voltage as a center of a modulation voltage amplitude Vpp. A half-wavelength voltage of the high-frequency modulation voltage is defined as Vπ(RF).

### Optical Engine and XR Glasses

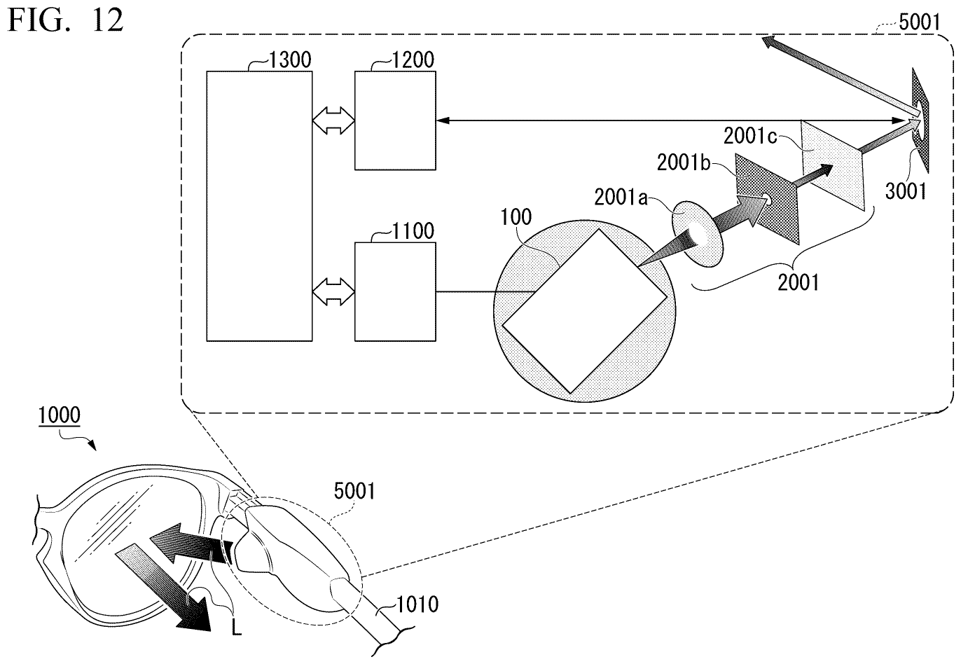

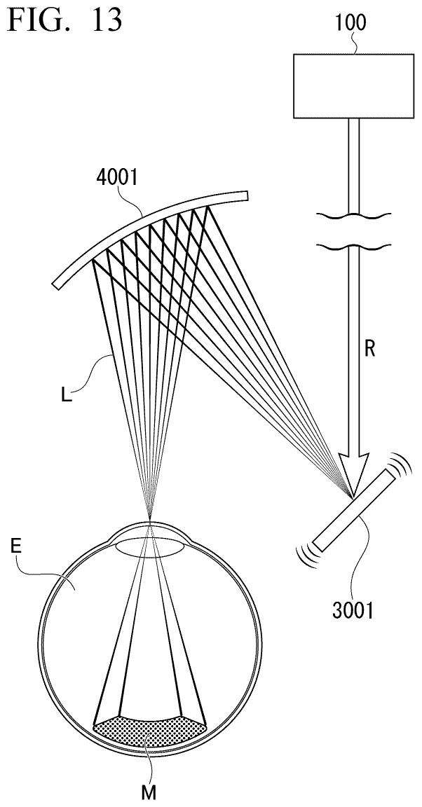

FIG. 12 is a conceptual diagram for explaining an example of XR glasses of the present disclosure. FIG. 13 is a conceptual diagram illustrating a state where an image is projected directly to retinas by laser light output from the light source module in the XR glasses illustrated in FIG. 12.

XR glasses (glasses) 1000 of the present embodiment is a glasses-type terminal. XR is a general term of virtual reality (VR), augmented reality (AR), and mixed reality. The reference sign L illustrated in FIG. 13 is image display light.

The XR glasses 1000 of the present embodiment illustrated in FIG. 12 is obtained by the light source module 100 according to the aforementioned embodiment being mounted on an optical engine 5001 installed on a frame 1010.

The optical engine 5001 includes the light source module 100, an optical scanning mirror 3001, an optical system 2001 that connects the light source module 100 to the optical scanning mirror 3001, a laser driver 1100, an optical scanning mirror driver 1200, and a video controller 1300 that controls these drivers as illustrated in FIG. 12.

As the optical scanning mirror 3001, it is possible to use an MEMS mirror, for example. In order to project a 2D image, it is preferable to use a 2-axis MEMS mirror that oscillates to reflect laser light by changing an angle in a horizontal direction (X direction) and a vertical direction (Y direction) as the optical scanning mirror 3001.

The optical system 2001 is adapted to optically process laser light output from the light source module 100. As the optical system 2001, it is possible to use an optical system including, for example, a collimator lens 2001a, a slit 2001b, and an ND filter 2001c. The optical system 2001 illustrated in FIG. 12 is just an example, and another configuration may be adopted.

In the XR glasses 1000 of the present embodiment illustrated in FIG. 12, laser light R emitted from the light source module 100 attached to the frame 1010 is reflected by the optical scanning mirror 3001, is further reflected by the lens 4001 of the XR glasses 1000, enters eyeballs E of a person as image display light L, and can project an image (video) directly to retinas M, as illustrated in FIG. 13.

Since the light source module 100 of the present embodiment is mounted on the XR glasses 1000 of the present embodiment, field efficiency is reduced.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

### EXPLANATION OF REFERENCES

1 Optical modulator
2 Substrate
3 Optical waveguide layer
32 Ridge
32b Second ridge waveguide
32c First ridge waveguide
Optical coupling part
52 Buffer layer
61A First ground electrode
61B Second ground electrode
62R, 62B, 62G Signal electrode
100 Light source module

What is claimed is:

1. An optical modulator comprising:
a substrate;
an optical waveguide layer that is formed on the substrate, includes a plurality of Mach-Zehnder waveguides including a first ridge waveguide and a second ridge waveguide for propagating visible light, which are aligned in parallel, and is made of lithium niobate;
a buffer layer that is formed on the optical waveguide layer;
a plurality of signal electrodes that are formed on the buffer layer and include interaction parts disposed along the plurality of Mach-Zehnder waveguides, respectively, and a plurality of first ground electrodes and a plurality of second ground electrodes that are disposed on both sides of each of the plurality of signal electrodes to be separated from the signal electrodes,
the signal electrodes being disposed above the first ridge waveguide,
the second ground electrodes being disposed above the second ridge waveguide;
a signal electrode extraction parts that connect the signal electrodes to pads disposed at an end side part of the substrate;
an optical coupling part that is disposed on a downstream side of the plurality of Mach-Zehnder waveguides and couples a plurality of visible light beams that have passed through the plurality of Mach-Zehnder waveguides;
a plurality of connection waveguides that connect a downstream side of each of the plurality of Mach-Zehnder waveguides to the optical coupling part; and
one output waveguide that is connected to the optical coupling part,
wherein the first ground electrodes, the second ground electrodes, and the signal electrode extraction parts are disposed at positions at which the first ground electrodes, the second ground electrodes, and the signal electrode extraction parts do not overlap with the optical coupling part in plan view.

2. The optical modulator according to claim 1,
wherein the number of Mach-Zehnder waveguides is three or more,
the number of the plurality of signal electrodes is three or more, the three or more interaction parts included in the signal electrodes, respectively, are parallel to each other in plan view and are aligned in an ascending order from the shortest one,
the optical coupling part is disposed closely to a downstream side of a signal electrode having the shortest interaction part from among the plurality of signal electrodes,
the number of the plurality of signal electrode extraction parts is three or more, and
each of two or more signal electrode extraction parts from among the plurality of signal electrode extraction parts extends so as not to intersect the others in a direction of equal to or less than 90° with respect to a direction in which the interaction parts extend from downstream ends of the interaction parts, crosses the plurality of connection waveguides in plan view, and is connected to a pad disposed at an end side part located closely to a downstream side of a signal electrode having the longest interaction part.

3. The optical module according to claim 1, wherein a higher-order mode removal part configured to remove a higher-order mode is included at a waveguide before branching to the first ridge waveguide and the second ridge waveguide on an upstream side of each of the plurality of Mach-Zehnder waveguides.

4. The optical modulator according to claim 1, wherein a width of the signal electrodes is equal to or greater than 1 μm and equal to or less than 4 μm.

5. The optical modulator according to claim 1, wherein a distance between the signal electrodes and the first ground electrodes and a distance between the signal electrodes and the second ground electrodes are equal to or greater than 1 μm and equal to or less than 12 μm.

6. The optical modulator according to claim 1, wherein a distance between centers of the first ridge waveguide and the second ridge waveguide is equal to or greater than 2 μm and equal to or less than 12 μm.

7. A light source module comprising:
the optical modulator according to claim 1; and
a plurality of light sources that are connected to the plurality of Mach-Zehnder waveguides and output visible light to be input to each of a plurality of input waveguides.

8. A light source module comprising:
the optical modulator according to claim 2; and
a plurality of light sources that are connected to the plurality of Mach-Zehnder waveguides and output visible light to be input to each of a plurality of input waveguides.

9. A light source module comprising:
the optical modulator according to claim 3; and
a plurality of light sources that are connected to the plurality of Mach-Zehnder waveguides and output visible light to be input to each of a plurality of input waveguides.

10. The light source module according to claim 7,
wherein each of the plurality of light sources is installed on an upper surface of each of individual light source bases,
the light source bases are joined to the substrate via a metal layer, and
an interval between joint surfaces of the light source bases and joint surfaces of the substrate is equal to or less than 5 μm.

11. The light source module according to claim 7,
wherein the plurality of light sources are installed on an upper surface of a common light source base,
the light source base is joined to the substrate via a metal layer, and
an interval between a joint surface of the light source base and a joint surface of the substrate is equal to or less than 5 μm.

12. An optical engine comprising:
the light source module according to claim 7; and
an optical scanning mirror that reflects light output from the light source module by changing an angle to display an image.

13. An optical engine comprising:
the light source module according to claim 10; and
an optical scanning mirror that reflects light output from the light source module by changing an angle to display an image.

14. An optical engine comprising:
the light source module according to claim 11; and
an optical scanning mirror that reflects light output from the light source module by changing an angle to display an image.

15. XR glasses comprising:
the optical engine according to claim 12 mounted thereon.

16. XR glasses comprising:
the optical engine according to claim 13 mounted thereon.

17. XR glasses comprising:
the optical engine according to claim 14 mounted thereon.

18. A method of driving the optical modulator according to claim 1, the method comprising:
modulating input light into output light with a high-frequency modulation voltage and a DC bias voltage; and
adjusting an operation point of the optical modulator by controlling the DC bias voltage.

19. A method of manufacturing the light source module according to claim 10, the method comprising:
joining the light source bases to the substrate via the metal layer by adjusting relative positions of the light source bases and the substrate through active alignment while monitoring an optical output.

20. A method of manufacturing the light source module according to claim 11, the method comprising:
joining the light source base to the substrate via the metal layer by adjusting relative positions of the light source base and the substrate through active alignment while monitoring an optical output.
